(19) United States
(12) Patent Application Publication
(10) Pub. No.: US 2012/0103161 A1
(43) Pub. Date: May 3, 2012

(54) Dental Mixing Pad Dispenser

(76) Inventor: Donna M. Smith, High Point, NC (US)

(21) Appl. No.: 12/915,443

(22) Filed: Oct. 29, 2010

(51) Int. Cl. B26D 7/06; B65H 16/06

(52) U.S. Cl. 83/733; 242/588.6

(57) ABSTRACT

A dental mixing pad dispenser is disclosed. The dental mixing pad dispenser has an upper portion, a lower portion, and a front portion. The upper portion and the lower portion come in contact with each other at a seam. The front portion also has an opening, whereby the upper portion is moveable from a closed position to an open position and back to the closed position. The dental mixing pad dispenser also has a roll of dental mixing pad material installed inside. The dental mixing pad material is configured into sheets which are wound around a center of the roll. The sheets of dental mixing pad material are positioned to be dispensed out of an opening in the dispenser.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for use in the dental examination and procedure process and more specifically to a dental mixing pad dispenser.

2. Description of Related Art

During dental procedures, various compounds may be mixed together. For example, epoxy used to hold dental crowns in place on an existing tooth or other type of structure. The epoxy may come in two separate containers and in order to activate the epoxy, the two compounds must be mixed together. Other types of compounds that may be used during dental procedures may include, but are not limited to, temporary cement, permanent cement, standard impression material, and the like. The dental materials, such as epoxy, typically come in two parts, a catalyst and a base that may be mixed together on a mixing pad. The mixing pad is typically supplied with the dental materials.

Dental assistants may have different methods and materials to facilitate the mixing of these dental compounds. Small disposable plastic bowls may be utilized. In other applications, disposable mixing pads or dental mixing sheets may be used. These mixing sheets may be layered upon one another and attached with some type of adhesive. These sheets are of a predetermined size and are dispensed one at a time by grasping the sheet and separating it from the stack and pulling it away.

One disadvantage of these disposable sheets is that the sheet itself is fixed in size. Should the dental assistant require a larger mixing area, multiple sheets must be pulled out and affixed together to create the larger mixing surface. Another drawback of the prior art mixing pad is that the pad is typically stored out in the open. Although the mixing pads may not need to be completely sterile, contamination of the pad surface may be experienced because they are not housed or contained in any type of container.

One drawback of the present dental disposable sheets is that the design of the mixing pad may create a cross-contamination between patients. The prior art mixing pads may be layers of dental pad material compressed on a cardboard base and attached on the sides with adhesive. The whole prior art mixing pads including the bottom, sides, and top are touched with duty gloves, if the top sheet is used to mix dental materials on and then torn off after use. The bottom and sides of the dental material are touched multiple times until the dental pad material is used completely. Utilizing the present invention, dental assistants may significantly decrease the risk of cross contamination. The present invention addresses these limitations of the prior art, and discloses a dental mixing sheet dispenser that allows the dental assistant the ability to dispense a mixing sheet that may be variable in length while protecting the integrity of the surface of the mixing sheet.

### SUMMARY OF THE INVENTION

A dental mixing pad dispenser is disclosed. The dental mixing pad dispenser has an upper portion, a lower portion, and a front portion. The upper portion and the lower portion come in contact with each other at a seam. The front portion also has an opening, whereby the upper portion is moveable from a closed position to an open position and back to the closed position. The dental mixing pad dispenser also has a roll of dental mixing pad material installed inside. The dental mixing pad material is configured into sheets which are wound around a center of the roll. The sheets of dental mixing pad material are positioned to be dispensed out of an opening in the dispenser.

A dental mixing pad dispenser is disclosed. The dental mixing pad dispenser has an upper portion, a lower portion, and a front portion. The upper portion and the lower portion come into contact with each other at a seam. The front portion also has an opening, whereby the upper portion is moveable from a closed position to an open position and back to the closed position. The dental mixing pad dispenser also has a roll of dental mixing pad material installed therein. The dental mixing pad material is configured into sheets which are wound around a center of the roll. The roll of dental mixing pad material also has a spool opening wherein a spool may be inserted into the spool opening, the spool further comprising tabs which, when installed on the roll of the dental material, support the roll of dental pad material when the roll is installed in the dental mixing pad dispenser. The sheets of dental mixing pad material are positioned to be dispensed out of the opening in the dispenser.

### BRIEF DESCRIPTION OF THE DRAWINGS

FIG. 1 displays a dental mixing sheet dispenser in a closed position in accordance with one embodiment of the present invention.

FIG. 2 displays the dental sheet dispenser of FIG. 1 in an open position.

FIG. 3 displays an exploded view of the mixing sheet dispenser.

FIG. 4 displays dental mixing sheet dispenser in an open position in accordance with a further embodiment of the present invention.

FIG. 5 displays a roll of dental mixing sheets in accordance with another embodiment of the present invention.

FIG. 6 displays the dental mixing sheet dispenser of FIG. 1 without a cutting blade.

FIG. 7 displays the dental mixing sheet dispenser of FIG. 4 without a cutting blade.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

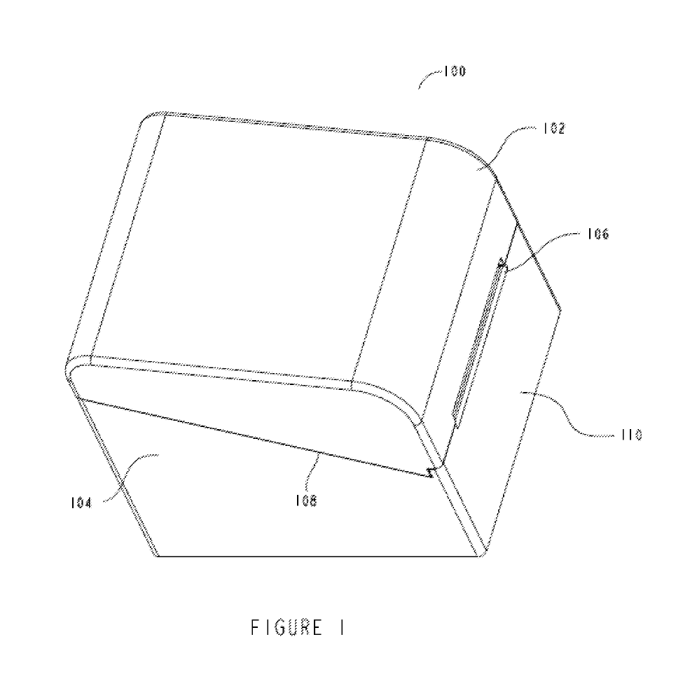

FIG. 1 displays a side perspective view of a dental mixing sheet dispenser 100 in a closed position in accordance with one embodiment of the present invention. The dispenser 100 has an upper portion 102 and a lower portion 104. The upper portion 102 and the lower portion 104 join together at a seam 108. The dispenser 100 also has an opening 106 positioned at a front portion 110 of the dispenser 100. As is described in greater detail in subsequent sections, the upper portion 102 may move towards the rear of the dispenser 100 by tapping the upper portion 102. Tapping the upper portion 102 causes the upper portion 102 to slide along the seam 108 away from the front portion 110.

One advantage of the present invention is that only slight pressure, such as a light tap, is necessary to move the dispenser 100 from the closed position to the open position. In addition, the dispenser is designed such that it may be moved from the open position to the closed position with a tap as well. Keeping the dental pad material isolated from the typical dental office environment may be important to keep the material from becoming cross contaminated. Cross contamination of the prior art dental pads may occur from liquids, such as water, being reflected out of a patient's mouth. Other cross contamination may occur if a dental assistant does not wear gloves or does not change gloves between patients and touches the entire prior art pad. Even if a dental assistant does not change their gloves regularly, the risk of cross contamination with the present invention may be limited to the exposed dental pad material as opposed to the entire pad of the prior art material.

In the embodiment of FIG. 1, the seam 108 may be oriented at an angle other than ninety degrees with respect to upper portion 102. Orienting the seam at an angle less than ninety degrees with respect to upper portion 102 may facilitate the movement of the upper portion 102 away from the front portion 110. Other embodiments may orient the seam 108 at ninety degrees with respect to upper portion 102 depending on how the upper portion 102 moves with respect to the lower portion 104.

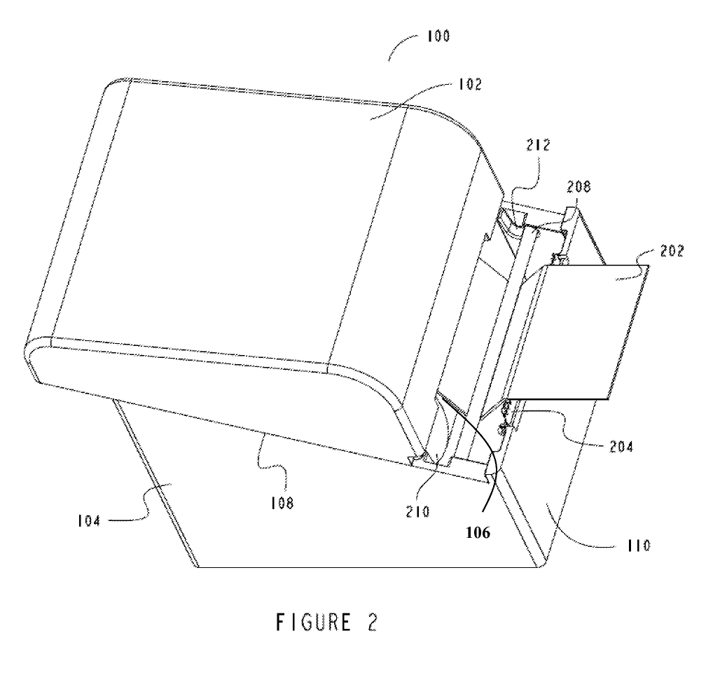

FIG. 2 shows the dispenser 100 with the upper portion 102 in an open position. In the open position, the upper portion 102 may move to a predetermined location with respect to the front portion 110. As mentioned previously, the upper portion 102 may move from the closed position to the open position by tapping the upper portion 102. In addition, while in the open position, the upper portion 102 may be separated from the lower portion 104 by applying additional pressure to the upper portion 102 away from the front portion 110. The upper portion 102 may need to be separated from the lower portion 104 in order to access a roll of dental pad material 210 when the roll needs to be replaced.

As can be seen in FIG. 2, the roll of dental pad material 210 may consist of multiple sheets 202 of dental mixing pad material. As those skilled in the art may appreciate, the dental mixing pad material may be similar to 3M™ ESPE™ dental materials. Alternatively, the dental mixing pad material may be composed of polyethylene material similar to the mixing pad material offered by Gennex Corporation. Some of the mixing pad material may be glazed or plastic coated on one side and have a mat coating on the other side. The inventive concepts of the present invention apply to any type of dental mixing pad material that may be rolled and dispensed with the dispensers described herein.

When the roll 210 is installed in the dispenser 100, the sheets 202 may be separated from the roll 210 and routed under a guide 208 and out the opening 106. The guide 208 may consist of a dowel or other type of rod that extends across the dispenser and may be parallel to the front portion 110. The guide 208 may be inserted into a guide slot 212. When a new roll 210 is installed in the dispenser 100, the guide 208 may need to be removed and reinserted into the guide slot 212 allowing the new sheets 202 to be routed under the guide 208. Also shown in FIG. 2 is a blade 204. The blade is positioned in the opening 106 and the sheets 202 may be routed over the blade 204. In this configuration, the dental hygienist or assistant may tear off a section of the sheet 202 using the blade 204 to cut the sheet 202 to the appropriate length.

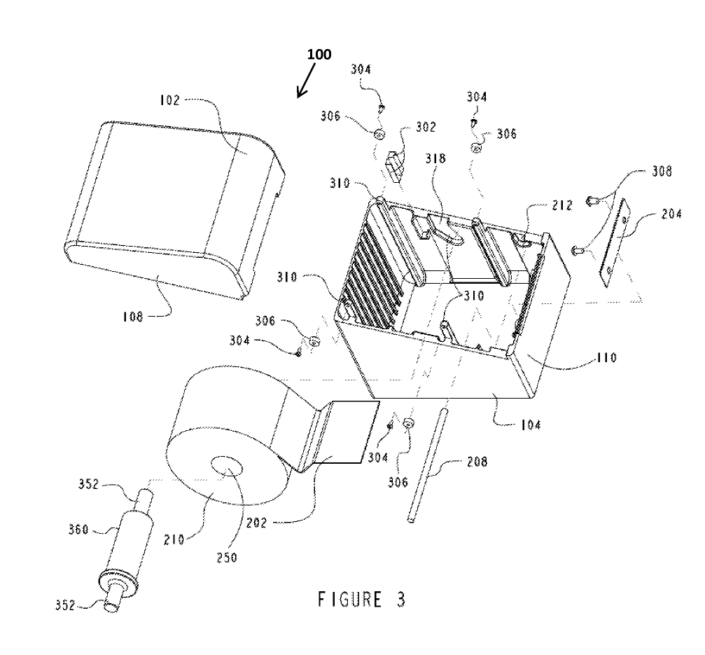

FIG. 3 displays an exploded view of the dispenser 100 with the upper portion 102 separated from the lower portion 104 granting access to the roll 210. A spool 360 may be inserted into a spool opening 250 on the roll 210. The spool 360 has tabs 352 which may be positioned in spool guides 318 which are on the dispenser 100. The tabs 352 allow the roll 210 to rotate when it is positioned within the dispenser 100. As can be seen in FIG. 3, the tabs may also guide the roll 210 in and out of the dispenser 100 when the roll 210 is removed and replaced.

The blade 204 may be held permanently in place by rivets 308. Alternatively, should the blade need to be removed periodically, screws may be used instead of rivets 308. A blade cover (not shown) may also be installed over the blade 204 during the initial installation of the roll 210 into the dispenser 100 to protect the user from cutting themselves. The blade cover may also provide protection during the manufacturing of the dispenser 100.

The upper portion 102 may have tracks (also not shown for ease of illustration) to allow the upper portion 102 to slide back away from the front 112. Wheels 306 attached on posts 310 and affixed with screws 304 may fit inside of the tracks. When the upper portion moves from the closed position to the open position, the upper portion 102 moves on the wheels 306. The upper portion 102 may be designed with “cuts” which allow the upper portion 102 to slide past the wheels 306 and ultimately be removed. The upper portion 102 may need to be removed in order to install a new roll 210.

In one exemplary embodiment, magnets 302 may be positioned on the upper portion 102 and lower portion 104 to allow the upper portion to be secured into place in either the open or closed position. As mentioned previously, the present invention may be designed to allow a minimum amount of pressure to be employed to open and close the dispenser 100. To facilitate this movement, the magnetic attraction between the magnets 302 may be designed accordingly.

In an alternate embodiment, springs may be used to slide the upper portion 102 backwards into the open position. In this embodiment, the springs may be mounted on the front 110 of the dispenser 100 as well as the upper portion. The compression force of the spring may be determined by the amount of force necessary to close the dispenser 100. Weaker springs allow the upper portion 102 to slide back to the closed position with just a simple amount of pressure applied to the upper portion 102. In the embodiment, as shown in FIGS. 1 and 2, with the seam 108 being less than perpendicular, a force may be applied directly to the upper portion 102 in a downward direction to close the dispenser 100.

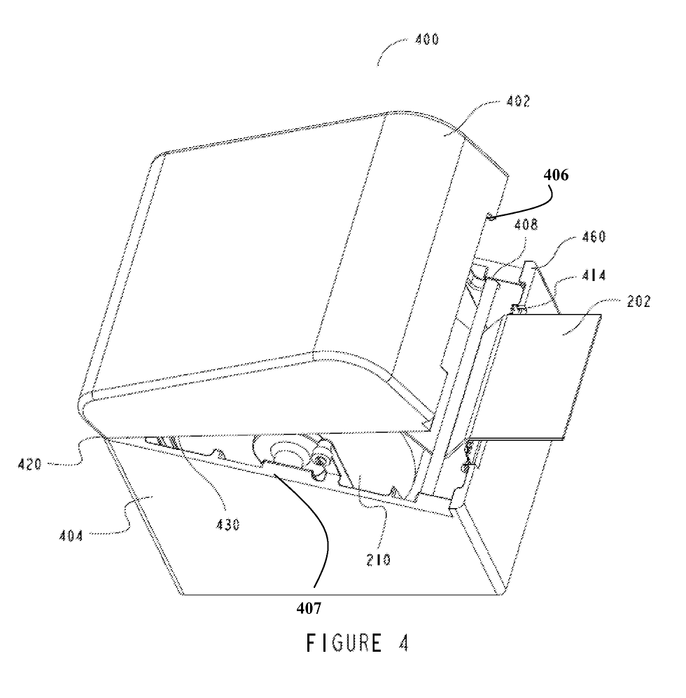

FIG. 4 displays a dispenser 400 in accordance with a further embodiment of the present invention. The dispenser 400 has an upper portion 402 and a lower portion 404. The upper portion 402 moves into an open position by rotating around a pivot point 420. In between the upper portion 402 and lower portion 404 is a seam 407. In the embodiment of FIG. 4, the seam 407 may be perpendicular to the upper portion 402. Dental pad sheets 202 housed on a roll 210 may be dispensed through an opening 406 positioned between the upper portion 402 and lower portion 404. The sheets 202 may be positioned under a guide 408 and over a blade 414.

A spring 430 or set of springs may be positioned in the seam 407 to provide the opening force which causes the upper portion to pivot around pivot point 420. The springs may be affixed to the lower portion 404 but not to the upper portion. This allows the upper portion to be rotated around about 180 degrees to allow the roll of dental pad material to be replaced.

Facilitating the locking into place of the upper portion 402 when in the closed position are magnets 460. The magnets 460 may be positioned on the front 412 of the dispenser 400. As those skilled in the art appreciate, the magnets 460 may be spring loaded such that when depressed, the magnets 460 engage. When depressed again, the magnets 460 disengage. Thus, when in the closed position, a light tap on the upper portion 402 causes the magnets 460 to disengage and the spring to push the upper portion 402 in an upward direction allowing access to the material 202. Once the sufficient amount of dental pad material 202 has been dispensed, the dental assistant simply taps the upper portion 402 once more moving the upper portion 402 into the closed position. The downward pressure placed against the upper portion 402 may also be sufficient to activate the magnets 460 to engage and secure the upper portion 402 into the closed position.

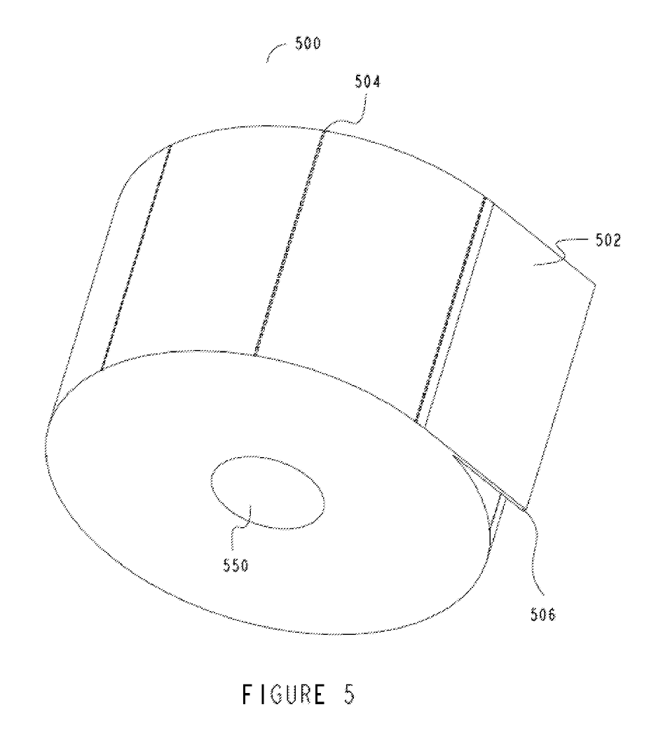

FIG. 5 displays a roll 500 of dental pad sheets 502 in accordance with one embodiment of the present invention. The dental pad sheets 502 have adhesive on an underside 506. In one exemplary embodiment, the adhesive may be applied to the entire underside 506. In an alternative embodiment, the adhesive may be applied to the middle of the underside 506. In yet another alternate embodiment, two lines of adhesive may be applied to the underside 506. The adhesive facilitates the rolling of the dental pad material 502 on to the roll 500 and keeps the roll 500 from unrolling.

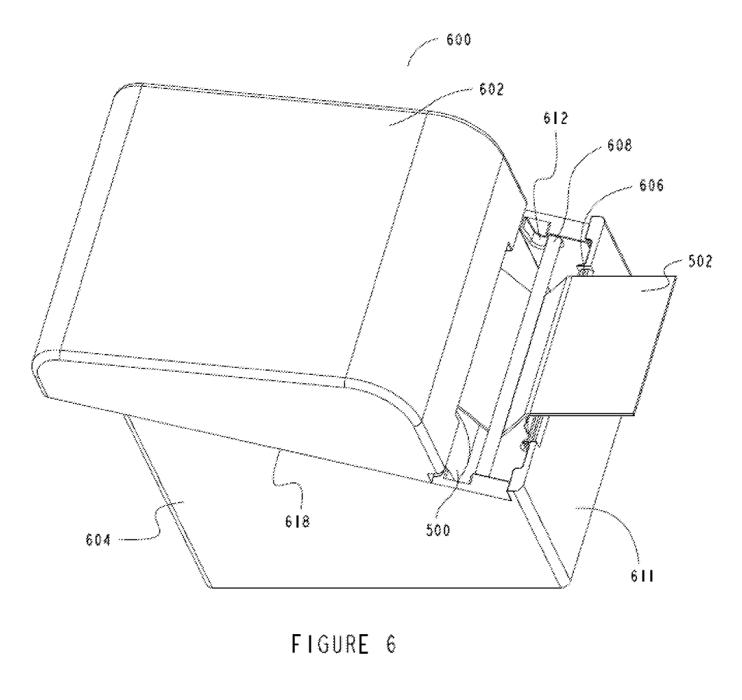

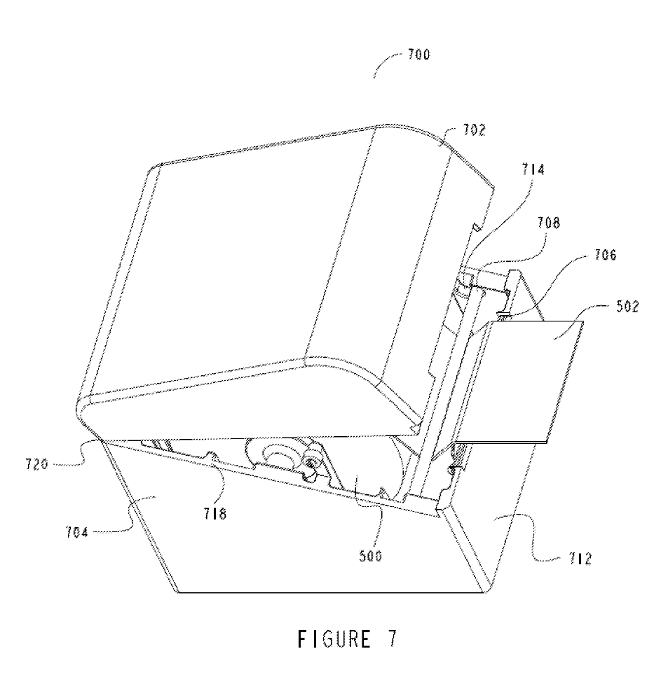

The roll 500 has perforations 504 that traverse the width of the sheet 502. The perforations 504 allow the sheet 502 to be separated into predetermined lengths should the dispenser 200 or 400 not have blade 204 or 404 (as shown in previous figures). These types of dispensers 600 and 700 are displayed in FIGS. 6 and 7 respectively. Roll 500 has a spool opening 550 which allows a spool (not shown) to be inserted. In one embodiment, the thickness of the material 502 may be about 0.005 inches thick.

In another exemplary embodiment, the diameter of the roll 500 may be about four inches wide. This includes about a one inch diameter spool opening 550 with the roll about three inches in diameter. In another exemplary embodiment, one side of the material 502 may be waterproof. Alternatively, the material may be waterproof on both sides. For purposes of illustration, “waterproof” may be defined as nonabsorbent with any liquid coming into contact with the side of the sheet 502 that is waterproof. In order to achieve the waterproof characteristic, the sheet 502 may be plastic coated on one or both sides. In one exemplary embodiment polyurethane may be used. As mentioned previously, one side of the material 502 may also be coated with a light adhesive in various locations.

FIG. 6 displays a dispenser 600 in accordance with a further embodiment of the present invention. As can be seen in FIG. 6, dispenser 600 has an upper portion 602, lower portion 604, and front portion 611. The upper portion 602 and the lower portion 604 join together at a seam 618. The dispenser 600 also has an opening 606 positioned at a front portion 611 of the dispenser 600. The upper portion 602 may move towards the rear of the dispenser 600 by tapping the upper portion 602. Tapping the upper portion 602 causes the upper portion 602 to slide along the seam 618 away from the front portion 611.

The opening 606 is of sufficient width to allow sheets of dental pad material 502 (FIG. 5) to be passed through. The roll 500 of dental mixing pad material is positioned within the dispenser 600. The sheets 502 originate from the roll 500 and are routed under a guide 608, and out the opening 606. The guide 608 is positioned in a guide groove 612.

In one exemplary embodiment, the position of the guide 608 in relation to the front portion 611 may be about one cm. When determining a particular distance separating the guide 608 and the front portion 611, the amount of space required for a user to grasp the sheet 502 may be taken into consideration. The perforations 504 (FIG. 5) in the sheets 502 allow the dental assistant to separate the sheets 502 into a various lengths as required.

FIG. 7 displays a dispenser 700 in accordance with a further embodiment of the present invention. As can be seen in FIG. 7, dispenser 700 has an upper portion 702 and a lower portion 704. The upper portion 702 and the lower portion 704 join together at a seam 718. The dispenser 700 also has an opening 706 positioned at a front portion 712 of the dispenser 700. The upper portion 702 may be rotated upwards, pivoting at pivot point 720 which is positioned at the rear of the dispenser 700 by tapping the upper portion 702.

The opening 706 is of sufficient width to allow the sheets 502 (FIG. 5) to pass through. The roll 500 (FIG. 5) of material is positioned within the dispenser 700. The sheets 502 that originate from the roll 500 are routed under a guide 708, and out the opening 706. The guide 708 is positioned in a guide groove 714.

In one exemplary embodiment, the position of the guide 708 in relation to the front portion 712 may be about one cm. When determining a particular distance separating the guide 708 and the front portion 712, the amount of space required for a user to grasp the sheet 522 may be taken into consideration. The perforations 504 in the sheets 502 allow the dental assistant to separate the sheets 502 into a various lengths as required.

What is claimed is:

1. A dental mixing pad dispenser comprising:
an upper portion, a lower portion, and a front portion, the upper portion and the lower portion contacting each other at a seam, the front portion further comprising an opening, the upper portion moveable from a closed position to an open position and back to the closed position,
a roll of dental mixing pad material, the dental mixing pad material configured into sheets which are wound around a center of the roll, the roll of dental mixing pad material further comprising a spool opening wherein a spool may be inserted into the spool opening, the spool further comprising tabs which, when installed on the roll of the dental material, support the roll of dental pad material when the roll is installed in the dental mixing pad dispenser, the sheets of dental mixing pad material positioned to be dispensed out of the opening.

2. The dental mixing pad dispenser of claim 1 wherein the upper portion slides along the seam when moving from the closed position to the open position.

3. The dental mixing pad dispenser of claim 1 wherein the upper portion pivots around a pivot point when moving from the closed position to the open position.

4. The dental mixing pad dispenser of claim 1 further comprising a blade, the blade positioned in the opening wherein the blade is used to cut the dental pad material into predetermined lengths.

5. The dental mixing pad dispenser of claim 2 further comprising springs, wherein the springs facilitate the sliding of the upper portion away from the front portion.

6. The dental mixing pad dispenser of claim 2 further comprising a magnet, wherein the magnet secures the upper portion against the lower portion when the upper portion is in the closed position.

7. The dental mixing pad dispenser of claim 3 further comprising springs, wherein the springs facilitate the pivoting of the upper portion around the pivot point.

8. The dental mixing pad dispenser of claim 3 further comprising a magnet, wherein the magnet secures the upper portion against the lower portion when the upper portion is in the closed position.

9. A dental mixing pad dispenser comprising:
an upper portion, a lower portion, and a front portion, the upper portion and the lower portion contacting each other at a seam, the front portion further comprising an opening, the upper portion moveable from a closed position to an open position and back to the closed position,
a roll of dental mixing pad material, the dental mixing pad material configured into sheets which are wound around a center of the roll, the sheets of dental mixing pad material positioned to be dispensed out of an opening in the dispenser, the roll of dental mixing pad material further comprising tabs, the tabs positioned in the center of the roll wherein the tabs support the roll when the roll is installed in the dental mixing pad dispenser.

10. The dental mixing pad dispenser of claim 9 wherein the upper portion slides along the seam when moving from the closed position to the open position.

11. The dental mixing pad dispenser of claim 9 wherein the upper portion pivots around a pivot point when moving from the closed position to the open position.

12. The dental mixing pad dispenser of claim 9 further comprising a blade, the blade positioned in the opening wherein the blade is used to cut the dental pad material into predetermined lengths.

13. The dental mixing pad dispenser of claim 10 further comprising springs, wherein the springs facilitate the sliding of the upper portion away from the front portion.

14. The dental mixing pad dispenser of claim 10 further comprising a magnet wherein the magnet secures the upper portion to the lower portion when the upper portion is in the closed position.

15. The dental mixing pad dispenser of claim 11 further comprising springs, wherein the springs facilitate the pivoting of the upper portion around the pivot point.

16. The dental mixing pad dispenser of claim 11 further comprising a magnet, wherein the magnet secures the upper portion to the lower portion when the upper portion is in the closed position.

17. A roll of dental mixing pad material comprising:
sheets of dental mixing pad material, the sheets wound around a center, the sheets having a top side and an underside, wherein the upper side is comprised of waterproof material and the underside has an adhesive affixed thereto.

18. The roll of dental mixing pad material of claim 17, wherein the sheets are about 0.005″ thick.

19. The roll of dental mixing pad material of claim 17, wherein the underside is also waterproof.

20. The roll of dental mixing pad material of claim 17 further comprising a perforation, the perforation extending across the sheet.

21. The roll of dental mixing pad material of claim 17 wherein the sheets are 3M™ ESPE™ material.
